(19) United States
(12) Patent Application Publication
(10) Pub. No.: US 2014/0044145 A1
(43) Pub. Date: Feb. 13, 2014

(54) Integrated metal alloy ingot remelting manager

(71) Applicants: Rodney L. Williamson, Albuquerque, NM (US); Joseph J. Beaman, Austin, TX (US)

(72) Inventors: Rodney L. Williamson, Albuquerque, NM (US); Joseph J. Beaman, Austin, TX (US)

(21) Appl. No.: 13/573,011

(22) Filed: Aug. 13, 2012

(51) Int. Cl. H05B 7/148; H05B 3/60

(52) U.S. Cl. 373/49; 373/70

(57) ABSTRACT

The present application describes and claims an integrated remelting manager for the VAR and ESR remelting processes comprising the following three integrated components: a pre-process manager, a real-time process manager and a post-process manager.

The present application also describes and claims a method of using the integrated remelting manager.

### CROSS-REFERENCE TO RELATED APPLICATIONS

Non-applicable

### STATEMENT REGARDING FEDERALLY SPONSORED RESEARCH AND DEVELOPMENT

Non-applicable

### THE NAMES OF THE PARTIES TO A JOINT RESEARCH AGREEMENT

Non-applicable

### INCORPORATION-BY-REFERENCE OF MATERIAL SUBMITTED ON A COMPACT DISC

Non-applicable

### BACKGROUND OF THE INVENTION

1. Field of the Invention

The invention relates generally to vacuum arc remelting and electroslag remelting processes. More specifically, it relates to an integrated metal alloy ingot remelting management method.

2. Description of the Related Art Including Information Disclosed Under 37 CFR 1.97 And 37 CFR 1.98

Remelting processes are widely used throughout the specialty alloys industry to make metal alloy ingots. The resulting ingots are then processed to produce materials that are used in many different industries throughout the world including, but not limited to, aerospace, chemical, nuclear, petroleum and energy production industries. The present application deals with two remelting processes: (1) vacuum arc remelting (“VAR”); and (2) electro-slag remelting (“ESR”).

In the VAR process, a cylindrically shaped, alloy electrode is loaded into the water-cooled copper crucible of a VAR furnace, the furnace is evacuated to low pressure (typically a few millibar), and a dc electric arc is struck between the electrode (cathode) and some start material (e.g. metal chips) at the bottom of the crucible (anode). The arc heats both the start material and the electrode tip, eventually melting both. As the electrode tip is melted away, molten metal drips off and an ingot forms in the copper crucible. Because the crucible diameter is larger than the electrode diameter, the electrode must move downward toward the anode pool at the required speed to keep the average distance between the electrode's tip and pool surface constant. This average distance is called the electrode gap. The objective of VAR is to produce an ingot that is free of macrosegregation, porosity, shrinkage cavities, or any other defects associated with uncontrolled solidification during casting. FIG. 1 depicts a schematic depiction of a VAR furnace.

In the ESR process, the electrode and crucible can have either a circular or rectangular cross sections. The electrode is lowered into a water cooled copper crucible and the tip is immersed in molten slag composed of various oxides and fluorides (e.g. CaO, MgO, Al₂O₃, CaF₂, etc.). Electrical power (usually ac, but sometimes dc) passing through the electrode is used to heat the slag and keep it in a molten state by resistive heating. The electrical current passes between the electrode and copper mold through the slag. This process is usually carried out under atmospheric pressure, sometimes under a blanket gas of argon. The ESR process is similar to the VAR process in that molten metal from the electrode tip drips off and forms an ingot in the mold. However, in the ESR process the metal droplets fall through the molten slag which is chemically tailored to refine the material from impurities and unwanted chemical species. The extent to which the electrode tip is immersed into the molten slag is called the immersion depth and is an important control parameter, in part determining the rate of slag consumption, current path and ingot surface quality. FIG. 2 shows a schematic depiction of the ESR process.

Several remelting process variables are monitored and recorded when the VAR and ESR processes are used in industrial settings. A typical set of variables for VAR might include process voltage, melting current, electrode position and/or drive velocity, drip-short frequency, furnace pressure, electrode weight, and inlet/outlet cooling water temperature. Similar data are collected for ESR (except for drip-short frequency) but might also include such important ESR variables as slag temperature and resistance. These data streams are usually logged to a computer at regular intervals, displayed on the computer screen, and simultaneously output to an analog recording device such as a strip-chart recorder. A recording device generates a permanent record of the process and, at the same time, provides data for evaluating the status of the process during or after operation.

Data provided by sensors attached to a remelting furnace can be analyzed in various ways to determine if the process is performing to expectation. The literature contains some analytical tools used to analyze sensor provided data. The data may be fed to a process variable estimator, e.g. a Kalman filter, from which one can obtain estimated values for the process variables used to characterize the process.

At the heart of a variable estimator is a set of first order, coupled, differential equations that describe the dynamics of the process. The variable estimates supplied by the estimator may be compared to measurements to determine if there are sensor failures or process upsets. Because variable estimators are capable of estimating variables that are not subject to measurement, or can only be measured in ways that are too intrusive, the estimator's output streams can be used to characterize aspects of the process that either cannot be, or are not, directly measurable. Examples of variables that can be estimated in that fashion include instantaneous electrode melt rate, the thermal distribution in the electrode, and the depth of the ingot pool atop the solidifying ingot. Variable estimators based on Kalman filter technology that describe electrode melting dynamics for both the VAR and ESR processes, including certain aspects of slag behavior for ESR are available. A variable estimator has also been developed and reported that captures some limited aspects of ingot solidification behavior during VAR. A comprehensive variable estimator comprising the dynamics of the entire remelting process has never been reported for either VAR or ESR.

Effective process management requires more than merely recording process variables, manipulating and processing those variables using estimators, filters and statistics, and evaluating the results to get relevant information about the process. An effective, innovative manager must allow the user to know what the process is doing while predicting with painstaking detail what is happening in the product. For ESR and VAR an effective remelting manager requires the application of a fast, accurate, ingot solidification model that faithfully describes ingot properties in response to process inputs. Neither the ESR nor VAR processes have a direct, real-time measurement of ingot quality. Accordingly, that information must be provided by predictive ingot models that run fast enough for corrective action to be taken during the melt. The idea of running predictive models in parallel with the remelting process as part of a process monitor is relatively new. Applicants implemented that concept in 2007 (see reference 2).

Process monitors that use variable estimators in connection with data monitoring and processing and high fidelity physics models, represents the apex of process manager development for remelting processes. It appears that the vast majority of industrial melt shops do not take advantage of these relatively advanced tools. The present invention comprises a much more advanced and comprehensive manager for remelting processes.

### BRIEF SUMMARY OF THE INVENTION

The present application describes and claims an integrated remelting manager for both the VAR and ESR remelting processes comprising three integrated components: 1) a pre-process manager; 2) a real-time process manager; and 3) a post-process manager.

The pre-process remelting manager component comprises: 1) multiple process reference commands; 2) a controller simulator; 3) a remelting process simulator; 4) multiple variable estimators; 5) a high fidelity physics (“HFP”) ingot model; 6) multiple pre-programmed process upsets; 7) a data pool; and 8) a data archive.

The method of creating a remelting process predictor of the present invention, comprises the steps of: 1) feeding the process reference commands into a controller simulator; 2) allowing the controller simulator to generate the process inputs that are required for the process to follow the process reference commands; 3) calculating and subsequently loading variable estimator gains in preparation for using the variable estimator to estimate process variables; 4) calculating and subsequently loading simulation parameters in preparation for using a HFP model to simulate ingot properties; 5) making available the process inputs to the remelting process simulator, variable estimators, HFP ingot model, data pool and data archive; 6) allowing the remelting process simulator to use the inputs to generate a predicted remelting furnace response in the form of a set of furnace variables that are updated at regular intervals with the inputs; 7) allowing the simulator to add measurement and process noise to the predicted outputs from the variable estimators (available in the data pool) to simulate the furnace response variables; 8) modeling the measurement and process noise as white, Gaussian noise with statistical characteristics matching those of the actual remelting furnace being simulated; and 9) using pre-programmed process upsets in connection with the remelting process simulator, variable estimators and HFP ingot model to predict their effects on ingot structure and quality.

In the preferred embodiment of the invention, the variable estimators are based on Kalman filter technology or other recursive estimation techniques such as Monte Carlo particle filters. The VAR tool uses two variable estimators, one each for the electrode and ingot. The ESR tool adds a third for slag properties. The HFP ingot model uses the simulated input data from the furnace to generate information on solidification, including but not limited to, temperature distribution in the ingot, liquidus and solidus positions and propagation velocities, thermal gradients in the mushy zone, local solidification time at all points in the ingot, and primary dendrite growth direction. All this data is saved in the data archive.

Finally, pre-programmed process upsets are used to change the process response to inputs in ways that mimic common process problems. These include, but are not limited to, changes in process efficiency, changes in arc energy distribution (VAR), and changes in electrode tip geometry, changes in slag temperature and resistance (ESR).

The real-time remelting process manager component of the present invention comprises: 1) multiple process reference commands; 2) an operating remelting process complete with sensors capable of providing process measurements; 3) multiple variable estimators; 4) an HFP ingot model; 5) a set of data testing parameters; 6) multiple test results; 7) a data pool; and 8) a data archive.

The method of using the real-time remelting process manager component of the present invention comprises the steps of: 1) feeding the process reference commands to the remelting furnace; 2) making available the measured outputs of the process in the data pool; 3) archiving the measured outputs; 4) calculating and subsequently loading variable estimator gains in preparation for using the variable estimator to estimate process variables; 5) calculating and subsequently loading simulation paramenters in preparation for using a HFP model to simulate ingot properties; 6) making the measured outputs available to the variable estimators and HFP ingot model; and 7) making outputs from the variable estimators and HFP ingot model available to the date tester via the data pool wherein data testing comprises the tests listed below.

1) Standard Data Tests:
a. VAR tests: electrode scram, arc short, arc-out, pressure spike, glow, helium drop-out; and
b. ESR tests: electrode scram, slag runout, power loss.

2) Setpoint Deviations Tests:
a. VAR tests: current, voltage, drip-shorts frequency or period, melt rate, electrode drive velocity, helium pressure, stirring coil current; and
b. ESR tests: current, voltage, voltage swing, melt rate, electrode drive velocity, slag resistance, resistance swing, power.

3) Innovations Analysis (Biased Measurement Residuals):
a. VAR tests: electrode gap, electrode position, current, electrode weight, voltage; and
b. ESR tests: immersion depth, electrode position, current, electrode weight, voltage.

All the test results are archived in easily readable text capable of being called up later or displayed automatically on the management computer screen. Finally, in real-time mode outputs from the variable estimators an HFP ingot model may be used for process controller feedback if the controller has been designed to accept and use such feedback.

The post-process remelting manager component of the present invention comprises: 1) multiple variable estimators; 2) an HFP ingot model; 3) a set of data testing parameters; 4) multiple test results; 5) a data pool; and 6) a data archive. The elements listed immediately above interact in in much the same was as in the real-time mode except that furnace data originate from the data archive instead of originating from an operating remelting furnace. That allows multiple data sets from multiple process runs to be analyzed by the manager simultaneously. If the variable estimators and HFP ingot model were not run for the live process, they may now be run using the archived process reference commands, and furnace input and output data. All data testing can be performed as if a live process were operating.

In addition to the tests listed above, the following tests can be performed in post-process management mode:

1) Means Deviations Tests for Furnace Outputs
a. VAR tests: current, voltage, drip-shorts frequency or period, melt rate, electrode drive velocity, average energy consumption, helium pressure, helium flow, cooling water flow; and
b. ESR tests: current, voltage, voltage swing, melt rate, electrode drive velocity, slag resistance, resistance swing, power, energy consumption, crucible cooling water flow, baseplate cooling water flow, water power absorption.

2) Means Deviations Tests for Estimator Outputs:
a. VAR tests: electrode thermal boundary layer, electrode gap, electrode position, process efficiency, fill ratio, voltage bias, melt rate, pool power, pool depth; and
b. ESR tests: electrode thermal boundary layer, slag temperature, immersion depth, electrode position, efficiency, fill ratio, voltage bias, melt rate, pool depth.

3) Deviations from Standard Furnace Output Curves
a. VAR tests: current, voltage, electrode drive speed, melt rate, furnace pressure, average energy consumption, drip-shorts frequency or period, helium pressure, helium flow rate, cooling water flow rate, cooling water inlet and outlet temperatures, cooling water power absorption; and
b. ESR tests: current, voltage, voltage swing, melt rate, electrode drive velocity, average energy consumption, slag resistance, resistance swing, power, cooling water flow rate (baseplate and crucible), cooling water inlet and outlet temperatures (baseplate and crucible), cooling water power absorption.

4) Deviations from Standard Variable Estimator Curves:
a. VAR tests: electrode thermal boundary layer, electrode gap, electrode position, process efficiency, fill ratio, voltage bias, melt rate, pool power, pool depth; and
b. ESR tests: electrode thermal boundary layer, slag temperature, immersion depth, electrode position, efficiency, fill ratio, voltage bias, melt rate, pool depth.
   The method of using the post-process remelting process manager component of the present invention comprises the steps of: 1) loading measured remelting furnace data from the data archive into the data pool; 2) plotting and inspecting data in the pool; 3) calculating and subsequently loading variable estimator gains in preparation for using the variable estimator to estimate process variables; 4) calculating and subsequently loading simulation parameters in preparation for using a HFP model to simulate ingot properties; 5) making the furnace data available to the process manager for use in the variable estimators and HFP ingot model; 6) making outputs from the variable estimators and HFP ingot model available to the data tester via the data pool, wherein data testing comprises standard data tests, set point deviations tests and innovation analysis also known as biased measurement residuals; and 7) generating and archiving reports that give details of all test results.

The standard data tests look for common process upsets that melt engineers typically track for quality assurance reasons. A scram occurs when the electrode suddenly backs out and is detected from the electrode position measurement. In VAR, short circuits, arc-outs, pressure spikes, glows and helium dropouts are also tested for. These are somewhat self-explanatory except for glows which usually occur due to electrode contamination or furnace air leaks. Glows are detected from pressure, voltage and melting efficiency.

These tests, as well as all the other data tests, are performed over the range the user sets per the software specifications. There are three start/stop criteria: (1) elapsed time, (2) current, and (3) ingot/electrode weight. A standard test report is generated which informs the user of the range, type, number and location of reportable events along with the specified test conditions. If several contiguous regions of the data meet the event criteria, they are not counted as separate events.

The setpoint deviation tests allow the user to confirm if the differences between the values for a furnace setpoint variable and its associated measured values exceed a specified threshold for a specified number of time steps. The threshold is typically specified as either a percentage difference or absolute difference. The variables listed are those for which setpoint values are often specified either the VAR or ESR processes. A setpoint deviation test report is generated which informs the user of the test range and conditions, and the number, location, duration, and average absolute magnitude of the setpoint deviations.

The means deviations tests allow the user to verify that mean values for each selected furnace or estimator variable in the test range fall within the specified deviation limits from the specified targets. Limits may be entered either as percentage or absolute deviations. A typical verification would be to ascertain whether average melt rate in the selected test range falls within a certain percentage of the specified target value. A test report is generated which shows the test range and conditions, the observed mean, the target minus the mean, and the test result for each selected variable.

The deviations from standard (reference) curves tests check to see how the furnace or estimator data sets compare to standard data curves derived from multiple archived data sets. The default test compares the curves for selected variables from each furnace data file with standard reference curves over the specified test range and sums values that are more than three standard deviations from the reference mean to get an outlier count. User defined deviations and durations may be substituted for the reference curve standard deviations by entering the desired deviation limits and durations in the appropriate numeric controls listed in the subpanel. In comparing the curves being tested to the standard reference curves, the software also calculates an average relative residual for each curve, the average ratio of the residual to the standard deviation (t statistic), and the probability that each curve matches the reference curve. A test report is generated which lists for each selected variable the number of outliers, the average relative residual, the minimum and maximum relative residuals, the positive and negative residual counts, t statistic, and the probability that the test curve matches (overlays) the standard reference curve.

The reference curve means and standard deviations for each variable at each point along the curve are stored in a standard reference file which must be loaded into the software before testing. The multi-file alignment criteria (start and end) that were used when the standard reference file was created are automatically loaded into the front panel when the reference file is loaded. If no standard reference file is available, one must be created using the process management software.

The innovations analysis looks for biased measurement residuals. A biased innovation occurs when the measured value for a variable differs from the value supplied by the variable estimator by a value exceeding that specified in the setup software. A persistent discrepancy between the estimator and the measurements indicates either a sensor failure or a process upset. The software of this invention flags an error whenever the biased condition persists longer than the number of cycles specified in the software. Both the time location and the length of the error condition are logged in the test results.

### BRIEF DESCRIPTION OF THE SEVERAL VIEWS OF THE DRAWINGS

FIG. 1 is a schematic drawing of the vacuum arc remelting process.

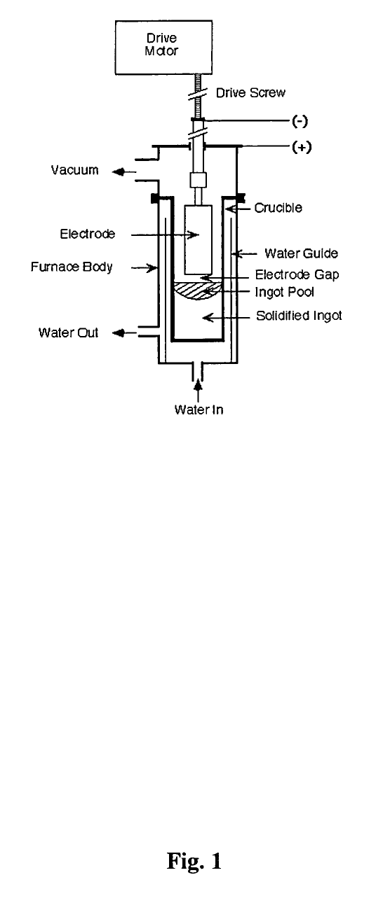

FIG. 2 is a schematic drawing of the electro-slag remelting process.

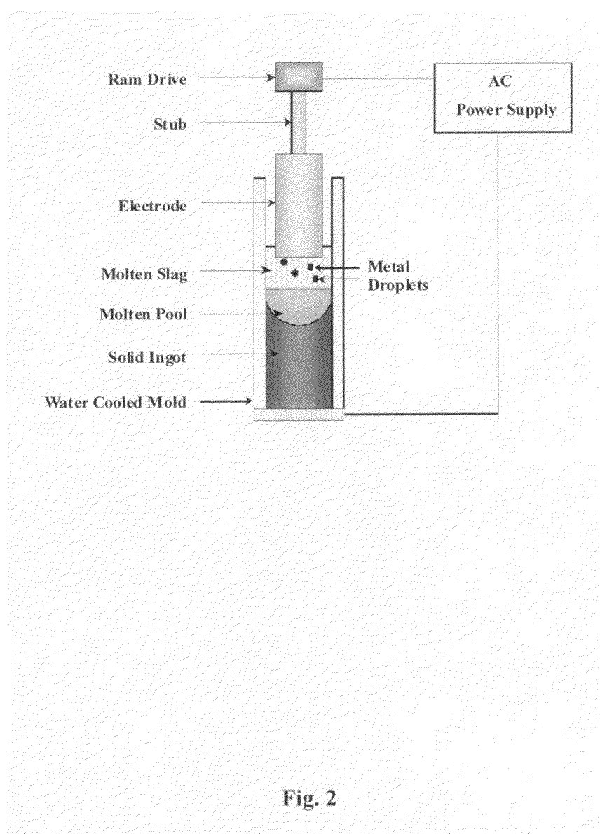

FIG. 3 is a schematic drawing of the integrated remelting process manager in pre-process mode.

FIG. 4 is a schematic drawing of the integrated remelting process manager in real-time mode.

FIG. 5 is a schematic drawing of the integrated remelting process manager in post-process mode.

### DETAILED DESCRIPTION OF THE INVENTION

Effective remelting of alloy ingot process management requires more than simply monitoring the process analogously to the way that traffic management requires more than just observing cars go by. If we examine the tools available, it is clear that much more can be accomplished in the way of process management than what is currently being practiced, which can help fill needs in the remelting industry that are currently unaddressed. The lingering question then becomes: what is currently lacking in even the most advanced remelting process monitor that needs to be included in a comprehensive, integrated remelting manager?

An effective remelting process manager should provide three levels of management: (1) preprocess management, (2) real-time process management, and (3) postprocess management. The tool described and claimed herein makes available to the remelting engineer user all three levels of capability.

Preprocess management adds a new dimension to process management by allowing the user to specify ahead of time what the output of the process should be. Further, preprocess management generates the control sequence necessary to produce the correct output. It also characterizes any dynamics that arise in response to the control action. The information then available allows the process engineer to determine whether sufficient control action is available to achieve the desired results and, if not, what the results will actually be. Second, preprocess management also allows the engineer to design optimized control paths before ever starting the process. Third, preprocess management is capable of evaluating the effects of various process upsets on the product and giving insight as to how one might respond to minimize any deleterious effects in the ingot. A main objective of the present invention is to make that capability-available throughout.

As the name indicates, real-time process management is performed in “real time” during the actual operation of the remelting process. Process monitoring as described herein is an example of real-time processing. However, the current generation of process monitors are lacking in some significant ways. First, they do not take advantage of online testing of data supplied by sensors that can, and should, be performed as the process is running and not after. Real-time data testing has the potential of informing the controller of anomalous process conditions that an appropriate controller response can correct. Second, the same observation equally applies to the outputs from the variable estimators utilized by the process monitor, especially those outputs for which no measurements are available. Third, the same comment applies to the outputs of any high fidelity physics models called by the process monitor that are running in parallel with the process.

The outputs of the estimators and HFP models may be considered as virtual measurements and, hence, are subject to the same kinds of tests being applied to actual measurement data. That enables the user engineer to see real-time electrode, slag, arc and ingot properties as well as their responses to process upsets and actual process commands. An effective manager tool automatically generates reports containing all relevant real-time testing results for review by quality control engineers.

Finally, there are important information and data that the user cannot glean from the process while it is running. The information in question necessarily includes all process assessments that require complete data histories for the entire remelting process for proper evaluation. For example, one might want to compare the average electrode melt rate for the entire remelting process to a specific value that represents the historical average of all melts on a particular remelting furnace. Clearly, the average for the entire melt cannot be computed until after the process has reached completion. Similar to real-time processing, an effective process manager tool automatically performs all post-processing of data the moment the furnace is shut off and generates all related reports immediately thereafter.

To perform effective preprocess management, real-time process management, and postprocess management, an efficient remelting manager must comprise integrated and complete relevant sensor outputs, process inputs, process variable estimators, as well as HFP models. For example, the fully integrated VAR process manager tool described and claimed herein incorporates all process inputs and furnace (sensor) outputs, an electrode variable estimator, an ingot solidification variable estimator, a high fidelity, 2-D, physics model of the ingot, a number of sophisticated data tests, and a process control simulator that simulates the process response to controller inputs and process upsets. Those elements are combined and integrated in such a way that, as a whole, they are capable of performing all the functions described above for the VAR process. The ESR manager is similarly constructed. The prior art reveals no such manager being used in the remelting industry or available for use in the remelting industry. Furthermore, the literature is devoid of any mention that such a comprehensive tool has been proposed. As a consequence of the lack of a comprehensive manager, remelting engineers do not have an overall, “big,” picture of what is happening during the operation of a remelting process in their melting shops. Consequently, they are often forced to resort to inspecting quality into remelting products instead of building quality in through effective process management.

The integrated remelting process manager of the present invention is an integrated combination of hardware and software capable of managing remelting processes to improve the quality of the resulting remelted ingots.

Given the critical mission of many materials that go through remelting steps in their process streams, it is not likely that post-process inspections of ingot material will ever be obviated by intelligent process management. However, intelligent process management has the potential to improve quality and product uniformity, increase yields, pinpoint potential trouble spots in the ingot for post-process inspection, and develop and evaluate control sequences that optimize the process based on product quality. Those advantages will be illustrated using the integrated VAR process manager but the ESR process manager is very similar.

First, the only required hardware is a computer. The computer communicates with the device that interfaces with and controls the remelting furnace. That device is usually a programmable logic controller (PLC) with associated hardware used to acquire data from sensors, send control signals to the power supply and electrode drive motor, manage relays and safety interlocks, etc. In connection with the illustration at hand, we must assume throughout that the remelting process the furnace is operated using a PLC. Typically, the computer might communicate with the furnace PLC over a serial communications port of some kind, for example, an Ethernet port, though there are other options. All relevant data can be sent back and forth in this manner. The computer is also used for all the computational tasks associated with the process manager.

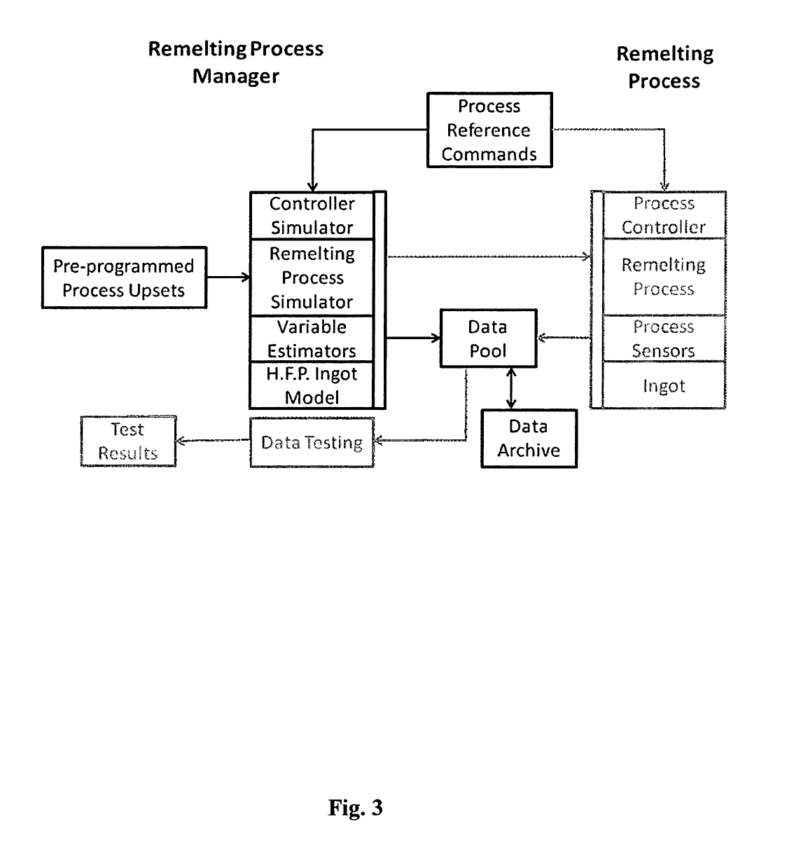

The software component of the present invention is an executable file that resides on the hard drive of the management computer along with a user-interface file that contains all the panels and windows used by the manager for the man-machine interface (MMI). It consists primarily of seven modules each representing a particular function of the tool. The functions are: 1) a remelting process simulator; 2) a remelting process control simulator; 3) a process variable estimator; 4) an HFP model of the ingot; 5) a set of data testing parameters and analysis routines; 6) multiple provisions capable of saving data in computer files; and 7) multiple provisions capable of generating, saving and displaying results as reports in easily readable formats. FIGS. 3-5 illustrate the manner in which those components are integrated in each management mode (pre-, real-time, and post-).

FIG. 3 illustrates the manager and process in preprocess mode. The light gray elements are not active. In preprocess mode, the remelting furnace is not operating so everything associated with it is grayed out. Also, data testing is grayed out because, before the process, there are no actual data to test or analyze. Elements in the figure that share borders are assumed to share everything required for each integrated module to function which includes data. So, for example, no feedback loop is explicitly shown in the remelting process between the process controller and the process sensors. It is assumed that data from the sensors are available for feedback if needed. The unity of the modules is emphasized by long, vertical rectangles along the borders. In preprocess mode, the manager accepts process reference commands (commonly called a melt recipe or melt schedule) which are fed into the controller simulator. The controller simulator generates process inputs (generally current and electrode drive speed for remelting processes) which are made available to the remelting process simulator, variable estimators, and HFP ingot model. The inputs may also be saved in the data archive (data file) along with data from the variable estimators and HFP ingot model. Thus, after running the remelting process manager in preprocess mode, the user acquires a record of the reference commands, the simulated process inputs, the process variable estimates, and the simulated ingot properties from the HFP model. The system is capable of receiving preprogrammed process upsets to ascertain the effects on predicted ingot properties. It is easy to see how the preprocess tool could be used to evaluate and optimize melt schedules as well as evaluate the effects of process outputs and investigate and evaluate means to counter those effects. Note that a double arrow is shown between the data pool and the data archive module because it is convenient to use archived data to initialize the manager in pre-process mode.

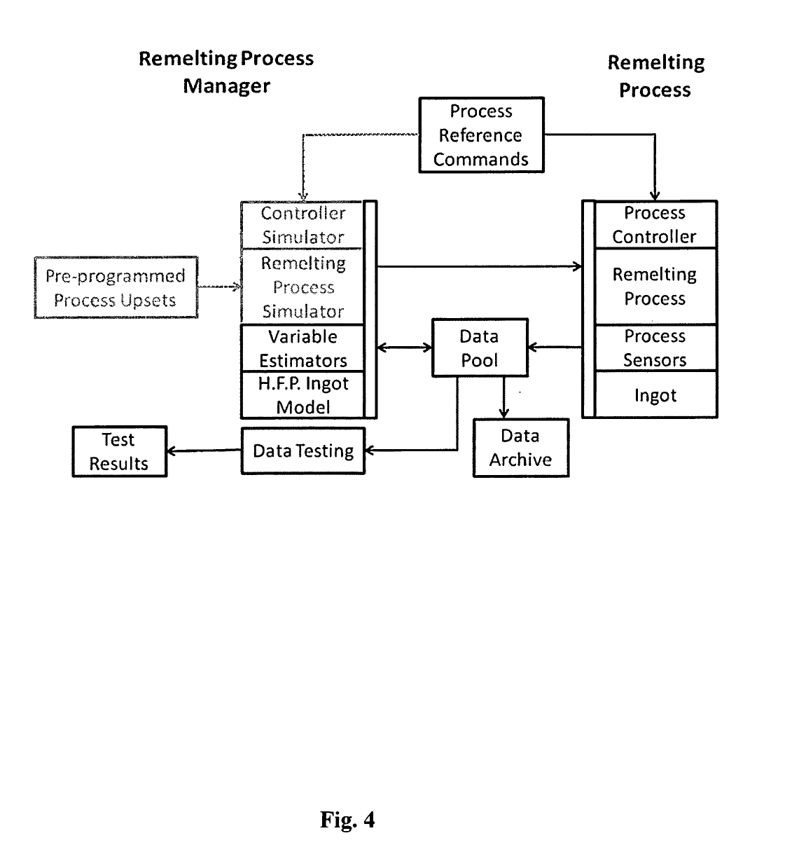

FIG. 4 illustrates the remelting process manager of this invention set in real-time mode. In that mode the furnace is operating and, therefore, is no longer grayed out. On the other hand, there is no need to run the controller simulator, remelting process simulator, or pre-programmed process upsets so these modules are shown as being inactive. All data required by the variable estimators and HFP ingot model are supplied by the actual furnace in the form of inputs and sensor outputs. Notably, the arrow between the remelting process manager and the data pool goes in both directions now because the manager both receives data from (inputs, sensor outputs) and sends data to (estimator and model outputs) the data pool. Also, because actual data are available, the data testing and test results modules are shown as active. At the conclusion of the remelting process, reports are available that describe the process and whether or not it operated within acceptable parameters, whether there were any process upsets or sensor failures, and the effect all this had on the predicted ingot properties. If something happened during the melt that the manager predicts might result in a melt related defect, the quality engineer will know where in the ingot to inspect for the defect from the manager report. Also, note that the arrow from the manager to the operating process is now active. Data from the variable estimators and HFP ingot model may be used as controller feedback to adjust the inputs if the controller has been designed to accept and use such feedback.

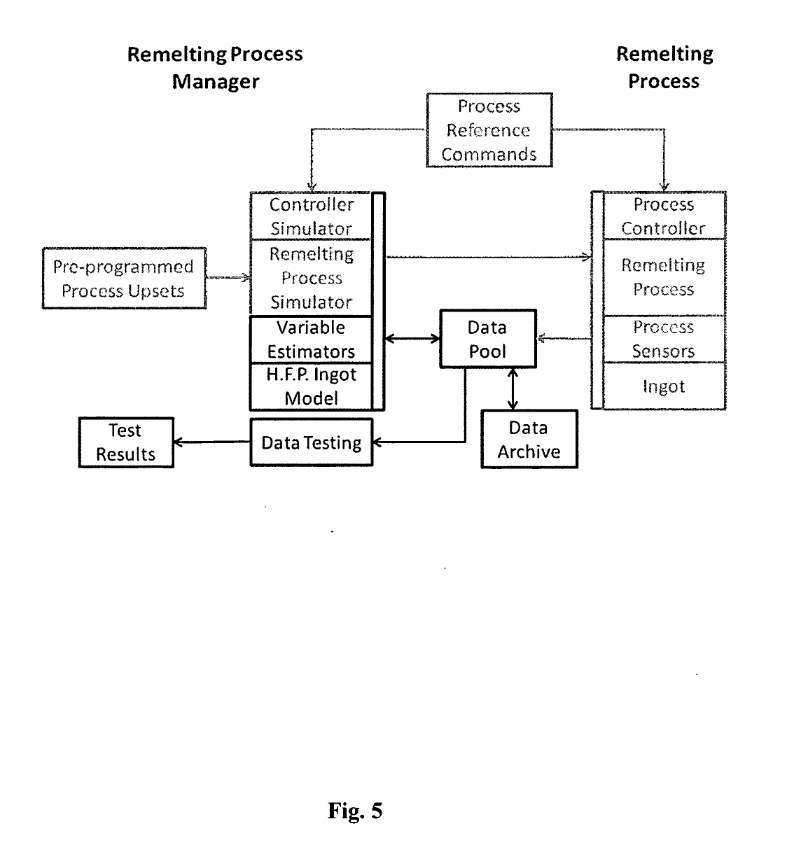

Finally, FIG. 5 shows the integrated remelting process manager in post-process mode. Like the preprocess mode, the furnace is not operating and is shown as inactive in the figure. In that mode, all data come from the data archive where it was deposited during an earlier melt for which the manager was not available, an earlier version was used, or tests are to be performed that require all the data from a complete melt to be present (as described above). Also, like in the real-time mode, the post-process manager both sends data to and receives data from the data pool. All the functionality available in the real-time mode is available in the post process mode as well as the additional results from data tests that can only be carried out after melting.

For the VAR implementation of the invention described and claimed herein, the software comprises the following elements:
1. a Kalman filter-based electrode estimator or observer capable of estimating electrode thermal boundary layer, electrode gap, electrode position, electrode weight, electrode melting efficiency, effective electrode cross-sectional area, arc voltage bias, melting current bias, electrode drive velocity bias, electrode melt rate, and total input power (arc power plus melt power) into the top of the ingot;
2. a Kalman filter-based ingot pool depth estimator or observer comprising as its outputs estimates of the ingot pool depth at various pre-defined points along the ingot radius (assuming cylindrical symmetry);
3. multiple provisions within the software to initialize and reset both the electrode and ingot estimators;
4. multiple provisions within the software capable of designing and calculating the Kalman gains required to couple the estimators to either (or both) actual and virtual measurements. In Kalman filtering, measurements are used to correct the estimates which are based on sets of first order differential equations describing the dynamics of the relevant system variables;
5. multiple provisions to communicate with the host furnace PLC through an interface, typically a serial interface, in the case where the manager is to be used with an operating VAR furnace, capable of both sending and receiving data and information and allowing the software to be synched to the furnace;
6. means to achieve automatic multiple melt processing by detecting when the furnace is powered on and off with the ability to wait in between melts in a “hold” mode;
7. multiple provisions to load furnace data from one or multiple archived data files in the case where the manager is to be used to process archived data capable of carrying out all analyses serially as if multiple melts are being performed;
8. means to define and save multiple data file formats capable of easily reading files of different types from different VAR furnaces into the manager;
9. a measurements filter capable of calculating residuals based on the differences between estimator outputs and furnace measurements and able to use the resulting information to detect sensor failures and process upsets (see reference 2);
10. multiple provisions capable of calculating and generating: melt rate from electrode weight data; melt rate from electrode position coupled with electrode gap and density data; power consumption defined as power consumed per unit mass of electrode melted; and cooling water power defined by the temperature difference between inlet and outlet cooling water multiplied by the specific heat of water, all figures being averaged over the furnace controller cycle time;
11. multiple provisions capable of calculating electrode gap from measurement models based on drip-short frequency, arc voltage and current;
12. multiple provisions capable of initializing and running an HFP model, the HFP model being capable of predicting ingot properties, so that when the furnace is functioning in live mode, the model is fully synched with the process controller so that it accepts the controller inputs to the furnace in real-time and completes its calculations of all relevant ingot properties before new controller inputs are sent. In this embodiment of the invention, applicants have used BAR, a 2-D ingot code capable of coupling descriptions of the electromagnetics, fluid mechanics, and heat transfer in the solidifying ingot to predict pool dynamics, thereby enabling detailed predictions in real-time of liquid metal velocity, pool geometry, local solidification time, and other parameters of metallurgical relevance (see reference 2 as well as references contained therein);
13. a VAR process simulator capable of accepting controller commands and accurately generating ingot properties;
14. a VAR control simulator capable of generating controller commands given a set of electrode and ingot reference variable setpoints that define the control goal, the control simulator being further capable of simulating four principal control modes including, but not limited to, melting current, melt rate, total power into the ingot pool, and ingot pool depth, the control modes further comprising electrode gap control thus allowing the user to set up a control profile in any of the control modes resulting in the control simulator generating the control curves required to reproduce the profile;
15. multiple provisions to perform VAR data tests in real-time including, but not limited to detecting and counting scrams (an event in which the furnace PLC suddenly and quickly raises the electrode thereby increasing electrode gap); arc shorting events (an event where the arc voltage goes to its short circuit value under full current); arc-outs (events where arcing ceases); furnace pressure spikes; e) detect and count glow events (an event characterized by a slight climb in voltage, a small increase in pressure, and a large decrease in efficiency); and instances where the helium gas used to cool the ingot drops below a pre-specified pressure and/or flow rate. Each event must meet or exceed both a threshold condition and a duration condition;
16. multiple provisions to perform setpoint deviations tests in real-time including, but not limited to, current, voltage, drip shorts, melt rate, helium pressure, and stirring coil current, a setpoint deviation being defined as an event where one or more controlled variables deviate from their associated setpoints or reference values by predefined amounts for pre-specified periods of time.
17. multiple provisions to perform the following deviations from means tests: current, voltage, drip shorts, melt rate, helium pressure, energy consumption, helium flow and water flow. Means deviations tests check to see that mean values for each selected furnace variable in the specified test range fall within the user defined deviation limits centered on the specified target values. These tests are performed as part of postprocessing because the specified range may include the entire melt.
18. multiple provisions to perform the following deviations from estimator means tests: electrode thermal boundary layer, electrode gap, electrode position, electrode weight, electrode melting efficiency, effective electrode cross-sectional area, voltage bias, electrode melt rate and total power input into the ingot pool. Means deviations tests check to see that mean values for each selected estimated furnace variable in the specified test range fall within the user defined deviation limits centered on the specified target values. These tests are performed as part of postprocessing because the specified range may include the entire melt.
19. multiple provisions to perform deviations from standard curves tests on the following process variables, current, voltage, electrode drive speed, electrode melt rate, furnace pressure, energy consumption, drip shorts, helium pressure, helium flow rate, cooling water flow rate, cooling water inlet temperature, cooling water outlet temperature, cooling water power, ingot pool depth at specified radial positions, thermal gradient across the ingot mushy zone at specified radial positions, velocity of the solidification front in the ingot at specified radial positions. These are postprocessing tests. Electrode melt rate will be used to illustrate deviations from standard curves testing. After the melt completes, a time history of melt rate may be generated from the data archived by the software. The curve that represents this time history may be compared to a standard curve that has been generated from many previous melts that have produced good ingots. The standard melt rate curve thus represents an entire family of melt rate curves, and possesses both a mean and a standard deviation at each point along the curve as well as other statistical properties. After being appropriately stretched or contracted, the measured melt rate time history for the melt under study may be compared to the standard curve. The difference between the two curves is calculated at each point, divided by the standard deviation at that point, and averaged over the entire melt to obtain a t-statistic for the melt rate history. Also, the absolute probability that the two curves match is calculated. Finally, absolute deviations of the melt rate history from the standard curve that exceed an allowable deviation for a specified period of time are also logged. Again, these tests may be carried out for any or all of the variables listed above.
20. multiple provisions to perform deviations from standard curves tests on the following estimated process variables, electrode thermal boundary layer, electrode gap, electrode position, electrode weight, electrode melting efficiency, effective electrode cross-sectional area, voltage bias, electrode melt rate, total input power into the ingot pool. These are postprocessing tests that are identical in concept to those described above in item xvii except they are performed on estimated variables and not measured variables.
21. multiple provisions in the software for calculating standard curves for the tests described in items xvii and xviii above from archived data sets.
22. multiple provisions to set up each test described in items xiii-xviii above using popup panels in the MMI and to save the results in a test template file that can be loaded into the software' at a future time to obviate the need for setting up testing by hand each time the software is run.
23. multiple provisions to set up the test range individually for each test specified in items xiii-xviii above. A test range is set by specifying a start variable, a start value, a stop variable and a stop value. There are four possible start and stop criteria: cursors, elapsed time, current and ingot/electrode weight. If the cursor mode is selected, the start/stop values are set by the cursor positions in the main plotting panel of the MMI. When any of the other start/stop criteria are used the specified start/stop values are used to determine the range over which to perform the tests. If the start value does not occur in the data, the software displays a popup window informing the user that a bad startup condition exists. If the stop condition is not met, the test simply runs to the end of the data set which may lead to correct though useless results. A typical example would be to specify an ingot weight of 200 pounds as a start criterion and an electrode weight of 300 pounds for a stop criterion. In that case, the selected test(s) would be started after 200 pounds of material had been melted and stopped when 300 pounds of electrode remained.
24. multiple provisions to generate text-based reports for each test specified in items xiii-xviii above and save them to the computer disk.
25. multiple provisions to generate text-based reports for each test specified in items xiii-xviii above on popup panels in the MMI for immediate inspection by the user.
26. multiple provisions to perform statistical analysis on all furnace, estimator, and high fidelity model data streams that have been acquired by managing multiple VAR melts. Clearly, this is a postprocessing function and requires that data from a sufficient number of melts be loaded into the software for the statistics to make sense. Analysis results are grouped by variable. Standard analysis includes the mean, standard deviation, t, t probability, f, f probability, and outlier flag. The t-value corresponds to the standard Student's t distribution function. It is calculated to test the hypothesis that the mean of the selected variable in the specified data set equals the grand mean of all the data sets for that variable in the analysis range. This number will be close to zero if the hypothesis is true. So, if t_{prob}=0.90 for some an variable in a particular heat in a set of 100 furnace data sets, you can be 90% confident that the mean for that variable is equal to the grand mean (the average value of that variable in all 100 data sets). An outlier is flagged if the mean is determined to be an outlier using standard quartile analysis. That is, if q1, q2 and q3 are the first, second and third quartiles, respectively, outliers are identified as any values that lie outside the range [q1−1.5*(q3−q1)] to [q3+1.5*(q3−q1)]. The f and f_{prob} numbers correspond to testing the hypothesis that, for a given variable, all the means for all the data sets are equal in the analysis range. f_{prob} is the probability that the hypothesis is true. In other words, if f_{prob}=0.85 for melt rate you can be 85% confident that all means are equal for this variable.
27. multiple provisions in the software to save and display the results of the statistical analysis described in item xxiv.
28. multiple provisions to define, save, and load a file from disk that contains all the paths for all the files required to run the manager and output data from the manager. These include all estimator gain files, libraries required by BAR, data files for managing archived data sets, test templates, standard furnace data and estimator data curves, and locations on disk where results and report files are to be stored after analysis. If present at execution, this file is automatically loaded and read, all files specified by the paths are loaded, and the manager appears ready to run. The integrated VAR manager described above presents a comprehensive view of the process to the remelting engineer giving him/her the ability to perform pre-, post- and real-time analysis on VAR data streams, bringing all the tools into one package. Some of these individual tools are currently available, for example, a VAR process monitor. Other tools, like preprocessing using a control simulator (item xii) and testing data and estimator histories against standard curves (items xvii and xviii), are not. As a package, the integrated VAR manager provides quality information that is needed to make intelligent ingot quality assessments that is currently missing from the specialty metals industry. If one or more of the pieces are missing, the ingot quality picture is incomplete and the likelihood of defective material ending up in finished parts increases.

What I claim is:

1. An integrated remelting manager useful for both Vacuum Arc Remelting and Electroslag Remelting processes comprising:
a. a pre-process manager further comprising multiple process reference commands, a controller simulator, a remelting process simulator, multiple variable estimators, a high fidelity physics (“HFP”) ingot model; multiple pre-programmed process upsets, a data pool; and a data archive;
b. a real-time process manager further comprising multiple process reference commands, an operating remelting process complete with sensors capable of providing process measurements, multiple variable estimators, an HFP ingot model, a set of data testing parameters, multiple test results, a data pool, and a data archive; and
c. a post-process manager further comprising multiple variable estimators, an HFP ingot model, a set of data testing parameters, multiple test results, a data pool, and a data archive.

2. The integrated remelting manager useful for both Vacuum Arc Remelting and Electroslag Remelting Processes of claim 1 wherein the variable estimators are based on Kalman filter technology.

3. The integrated remelting manager useful for both Vacuum Arc Remelting and Electroslag Remelting Processes of claim 1 wherein the variable estimators are based on recursive estimation techniques including, but not limited to, Monte Carlo particle filters

4. A method of using the integrated remelting manager of claim 1 comprising the steps of:
a. creating a remelting process predictor which further comprises the steps of:
i. feeding the process reference commands into a controller simulator;
ii. allowing the controller simulator to generate the process inputs that are required for the process to follow the process reference commands;
iii. calculating and subsequently loading variable estimator gains in preparation for using the variable estimator to estimate process variables;
iv. calculating and subsequently loading simulation parameters in preparation for using a HFP model to simulate ingot properties;
v. making available the process inputs to the remelting process simulator, variable estimators, HFP ingot model, data pool and data archive;
vi. allowing the remelting process simulator to use the inputs to generate a predicted remelting furnace response in the form of a set of furnace variables that are updated at regular intervals with the inputs;
vii. allowing the simulator to add measurement and process noise to the predicted outputs from the variable estimators (available in the data pool) to simulate the furnace response variables;
viii. modeling the measurement and process noise as white, Gaussian noise with statistical characteristics matching those of the actual remelting furnace being simulated;
ix. using pre-programmed process upsets in connection with the remelting process simulator, variable estimators and HFP ingot model to predict their effects on ingot structure and quality;
b. running the real-time process manager which further comprises the steps of:
i. feeding the process reference commands to the remelting furnace;
ii. making available the measured outputs of the process in the data pool;
iii. archiving the measured outputs;
iv. calculating and subsequently loading variable estimator gains in preparation for using the variable estimator to estimate process variables;
v. calculating and subsequently loading simulation parameters in preparation for using a HFP model to simulate ingot properties;
vi. making the measured outputs available to the variable estimators and HFP ingot model;
vii. making outputs from the variable estimators and HFP ingot model available to the data tester via the data pool, wherein data testing comprises standard data tests, set point deviations tests, and innovation analysis also known as biased measurement residuals;
c. running the post-process manager which further comprises the steps of:
i. loading measured remelting furnace data from the data archive into the data pool;
ii. plotting and inspecting data in the data pool;
iii. calculating and subsequently loading variable estimator gains in preparation for using the variable estimator to estimate process variables;
iv. calculating and subsequently loading simulation parameters in preparation for using a HFP model to simulate ingot properties;
v. making the furnace data available to the process manager for use in the variable estimators and HFP ingot model;
vi. making outputs from the variable estimators and HFP ingot model available to the data tester via the data pool, wherein data testing comprises standard data tests, set point deviations tests, and innovation analysis also known as biased measurement residuals; and
vii. generating and archiving reports that give details of all test results.
